(19) United States
(12) Patent Application Publication
(10) Pub. No.: US 2007/0113989 A1
(43) Pub. Date: May 24, 2007

(54) Cut-free width-adjustable horizontal blind

(76) Inventor: Law Yu Kuen, New Territories (HK)

Correspondence Address: Michael D. Yablonsky, Ph.D., Esq.;Law Office of Sergei Orel, LLC, 660 Anderson Ave, Cliffside Park, NJ, 07010, US

(21) Appl. No.: 11/601,188

(22) Filed: Nov. 18, 2006

(30) Foreign Application Priority Data
Nov. 19, 2005 (CN) 200520146186.8

(51) Int. Cl. E06B 9/30

(52) U.S. Cl. 160/168.1 R

(57) ABSTRACT

Cut-free width-adjustable horizontal blinds are a type of horizontal blinds that can adjust the width. The width of the blinds' upper rail, slat, and lower rail can be adjusted without cutting, thus matching the blind to different types of windows. By using a simple structure to coordinate different components, the blinds can both maintain usage and be applied to different windows with different width, without cutting. It is both convenient for the users and is lower in cost because manufacturers can mass produce it, thus achieving both goals.

### TECHNICAL FIELD

This invention is a type of horizontal blinds, to be exact, a type of cut-free width-adjustable horizontal blinds.

### BACKGROUND

Horizontal blinds are a type of blinds that uses pulling ropes to assemble and control overlaying slats to obstruct sunlight. The user can control the up-and-down as well as the angle of blind slats to adjust the light in the room.

The blinds that are currently in the market, as shown in FIG. 1, assembles the upper rail, slats, and lower rail in one piece. It is not possible to break into sections or adjust the width without cutting. Thus, every time when a user wants to install a window with a different width, he or she needs to purchase a blind with different width. This is very inconvenient, both from the user's point of view, and from the manufacturer's point of view. The user has to accurately measure the width of the window every time, and has to spend some time waiting for the manufacturing. At the same time, the manufacturer has to produce a small amount of blinds for each different width. This is not suitable for any business model, because it causes a lot of waste both for money and time.

### SUMMARY OF THE INVENTION

Based on the abovementioned issue, this invention provides a cut-free width-adjustable horizontal blind, the width of whose upper rail, slat, and lower rail can be adjusted to control the horizontal blind's width.

To realize this goal, this horizontal blind provides a cut-free width-adjustable horizontal blind. Its features include:

An upper rail is on top of the horizontal blind. This upper rail can be divided into three sections: an upper rail central frame, and upper rail left extension and upper rail right extension that extend out to both left and right side from the central frame. This upper rail central frame is hollow. The ends of its front edge and back edge curve inside to form an upper rail extension holder. On one edge of the upper rail central frame, there are several upper rail central frame screw holes. At the same time, both upper rail extensions have similar structures as the upper rail central frame. The ends of both their front edge and back edge curves inside to form an upper rail extension slider. At the right part of the upper rail left extension, and at the left part of the upper rail right extension, there are several upper rail extension screw holes. Since the extensions are slightly smaller than the central frame, the upper rail extension slider can slide through within the upper rail extension holder. Thus the upper rail central frame, the upper rail left extension, and the upper rail right extension are assembled together. Their hollow centers are connected together to form a mechanical combination box. Further, at the end of one of the upper rail extensions there is a slat flipping box hole and a pulling rope stopper.

A set of mechanical components is placed into the upper rail mechanical combination box. These mechanical components include: several pulling wheel bases, several pulling wheels that are mounted on these bases, a slat flipping box, an axis that passes through these components, and a pulling rope stopper. These pulling wheel bases and the slat flipping box can move horizontally on the axis. However, these blind mechanical components have the same structure as current horizontal blinds. Beneath the slat flipping box is a flipping shaft. Several pulling ropes pass through the pulling rope stopper. All pulling wheel bases, except for the central one, will have the pulling rope pass through to connect the slats with the lower rail. Further, two pulling ropes pass through all the wheels in the wheel bases, extending downward from the wheel bases to the lower rail, to mount the slats and adjust their angles.

Several slats are between the upper rail and the lower rail. These slats have two sections: left section and right section. They overlap in the middle. The right side of the left section overlaps the left side of the right section. The left section is a slat with an arc profile, with at least one pulling rope hole in the middle. The right section is a mirror view of the left section. Both the left section and right section have an arc profile, so that they can overlap.

A lower rail is at the bottom of the horizontal blind. The lower rail has three sections: a lower rail central frame in the center, and a lower rail left extension and a lower rail right extension, which extends to both left and right sides of the central frame. The edge of the lower rail central frame curves inside to form a lower rail extension holder. At the bottom of the lower rail central frame are several screw holes. The structure of the lower rail left/right extension is similar to the lower rail central frame. Their edges curve inside to form a lower rail extension slider. At the right side of the lower rail left extension, and at the left side of the lower rail right extension, there are several lower rail extension screw holes. Since left/right extensions are slightly smaller than the lower rail central frame, the lower rail extension sliders can slide within the lower rail extension holder. The lower rail central frame, lower rail left extension, and lower rail right extension are connected together. The hollow portion of their center thus form a bottom slat slot to hold the bottom slat. Thus the upper rail, slats, and lower rail will be assembled together through the pulling ropes and ladder ropes.

By combining simple structure of different components, this horizontal blind both preserves the usage pattern of horizontal blind, and can be applied to windows of different sizes without cutting. It both is convenient for the users, and allows the manufacturers to do mass production to lower the cost.

### BRIEF DESCRIPTION OF THE FIGURES

FIG. 1 is the three dimensional view of regular horizontal blinds currently on market.

FIG. 2 is the three dimensional view of this horizontal blind: Cut-free width-adjustable horizontal blind.

FIG. 3 is the dissect view of the blind mechanical components for the horizontal blinds shown in FIG. 2.

FIG. 4 is the front view of the width adjustment for the cut-free width-adjustable horizontal blind shown in FIG. 2.

FIG. 5A is the three dimensional view of the width adjustment for the upper rail of the horizontal blind shown in FIG. 4.

FIG. 5B is the three dimensional view of the width adjustment for the slats of the horizontal blind shown in FIG. 4.

FIG. 5C is the three dimensional view of the width adjustment for the lower rail of the horizontal blind shown in FIG. 4.

FIG. 6 is the three dimensional view of the upper rail central frame and upper rail left/right extension of the horizontal blind shown in FIG. 4.

FIG. 7 is the rear view of the upper rail for the horizontal blind shown in FIG. 4.

FIG. 8 is the three dimensional view of the lower rail central frame and lower rail left/right extension of the horizontal blind shown in FIG. 4.

FIG. 9 is the bottom view of the lower rail for the horizontal blind shown in FIG. 4.

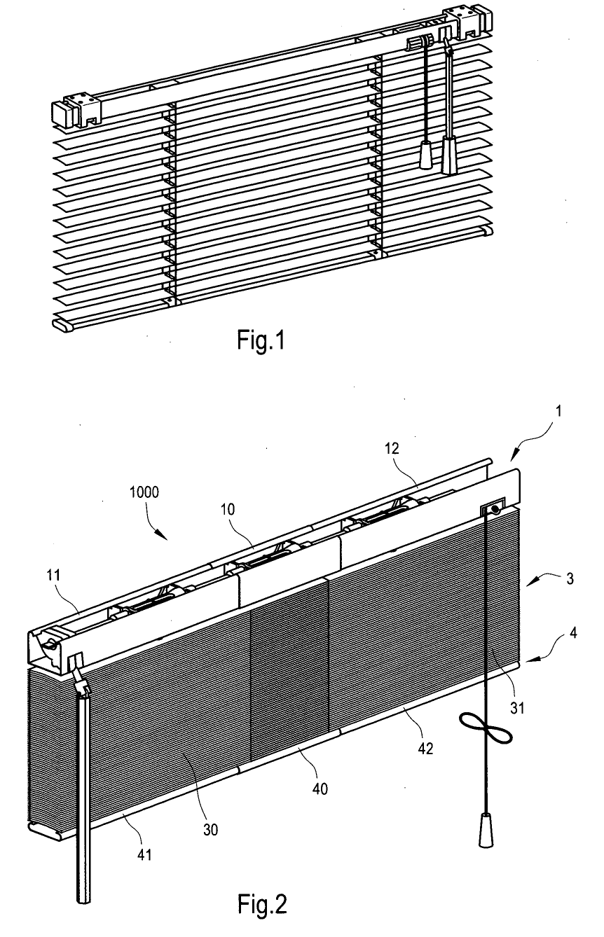

### DETAILED DESCRIPTION OF THE INVENTION

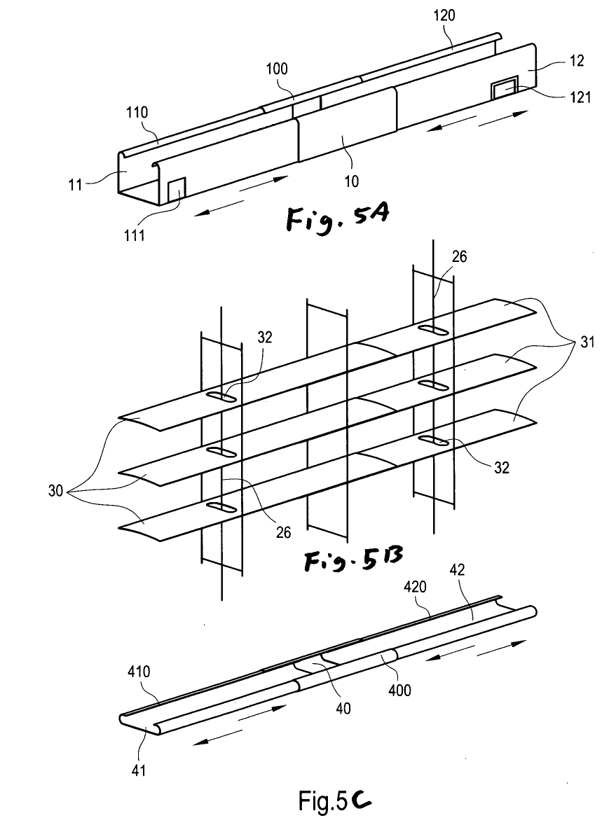

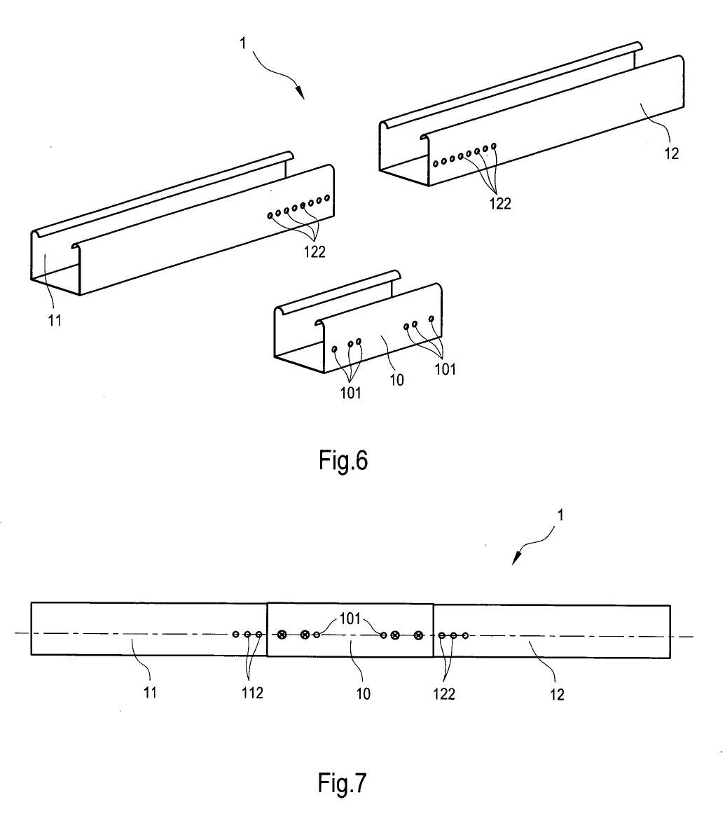

Please refer to FIG. 2 first. FIG. 2 shows the three dimensional view of this horizontal blind: Cut-free width-adjustable horizontal blind 1000. By moving upper rail left/right extension 11/12 towards/against upper rail central frame 10, moving lower rail left/right extension 41/42 towards/against lower rail central frame 40, adding screws to the upper rail central frame screw hole 101 (as shown in FIG. 6) and upper rail left/right extension screw hole 112/122 (as shown in FIG. 6) to fix the length of upper rail 1, and adding screws to the lower rail central frame screw hole 401 (as shown in FIG. 9) and lower rail left/right extension screw hole 412/422 (as shown in FIG. 9) to fix the length of lower rail 4, the user can adjust the length of upper rail 1 and lower rail 4 for the blind 1000 without cutting. The overlap percentage of slat left section 30 and right section 31 should also be adjusted to change the length of slat 3 (FIG. 5B). Thus the width of the horizontal blind 1000 can be adjusted to fit in to different windows.

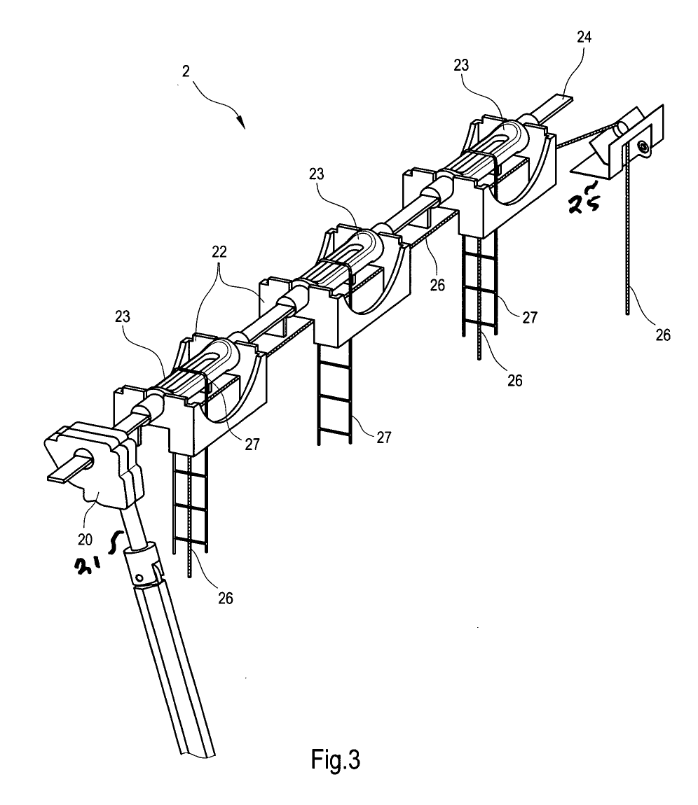

Please refer to FIG. 3 next. FIG. 3 is the dissect view of the blind mechanical component set 2 for the horizontal blinds 1000. The blind mechanical component set 2 has several components. The basic structure is similar to the current horizontal blind. Both are placed in the mechanical component box. Near the end of the front edge of upper rail left extension 11, there is a flipping box hole 111 (as shown in FIG. 5A). Flipping axis 21 passes through flipping box hole 111 to control the mechanical flipping axis 24 that is inside the flipping box 20. The movement of flipping axis 24 passes the movement to the flipping wheel 23 in the wheel base 22. Thus the two ladder rope 27 that are attached to the flipping wheel 23 will move toward opposite directions, and makes the slat 3 that associated with the ladder rope 27 change its angle, thus adjusting its rate of blocking sunlight. At the same time, at almost the end of the front edge of the upper rail right extension 12, there is a pulling rope stopper 25 (as shown in FIG. 3). When pulling the end of pulling rope 26, which is beneath the pulling rope stopper 25 and passes through the pulling rope stopper hole 121 (FIG. 5A), the other end of pulling rope 26 that is beneath the two left/right wheel base 22 will move up simultaneously to raise slat 3 and raise rail 4. On the other hand, when loosening the end of pulling rope 26 that is beneath pulling rope stopper 25, that other end of pulling rope 26 that is beneath the two left/right wheel base 22 will move down simultaneously to lower slat 3 and lower rail 4. The unique part of this horizontal blind 1000 is that all the wheel base 22 and flipping box 20 move horizontally over the axis 24. Thus when the user changes the length of horizontal blind 1000, the wheel base 22 and flipping box 20 will move horizontally on flipping axis 24, matching the movement of upper rail left/right and lower rail left/right extensions. This blind 1000 can still function well.

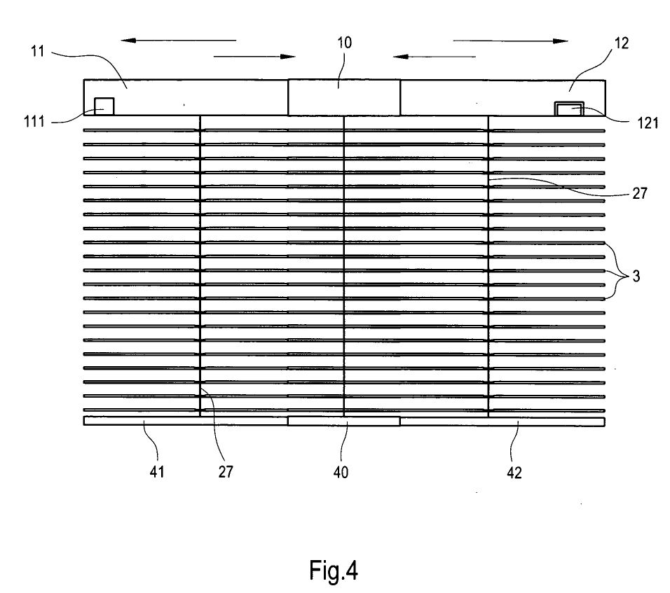

FIG. 4 and FIG. 5A-5C are the front and three dimensional views of horizontal blind 1000 showing it's adjustable width. The upper rail left/right extension 11/12 and lower rail left/right extension 41/42 have the same structure and section as the upper rail central frame 10 and lower rail central frame 40, and they are mirroring each other. But the upper rail left/right extension 11/12 and lower rail left/right extension 41/42 are slightly smaller than the upper rail central frame 10 and lower rail central frame 40. Thus the upper rail extension slider 110/120 and lower rail extension slider 410/420 can slide along upper/lower rail extension holder 100/400. Thus upper/lower rail 1/4's length can be adjusted. This is feasible because slat left section 30 and right section 31 are both arc shaped slats. In the center of slat 3 there is no pulling rope hole. Instead, there are multiple pulling rope holes on the body of slat left section and right section. When the users want to reduce the width of horizontal blind 1000, they only need to push the upper rail left/right extension 11/12 towards upper rail central frame 10, and push the lower rail left/eight extension 41/42 towards lower rail central frame 40. This will reduce the width of upper/lower rail 1/4. Since slat left/right section 30/31 have the same section shape, the right end of the slat left section 30 will overlap the left end of the slat right section 31. Besides, since there is no pulling rope 26 passing through the center of slat 3, where slat left/right section 30/31 overlap, the overlapped part of slat left/right section 30/31 can move smoothly. Controlling the overlap rate of slat left/right section 30/31 will control the length of slat 3. That means shortening the width of the upper/lower rail 1/4 will pull slat 3 that is placed between them to automatically adjust to the same length, so that the width of horizontal blind 1000's width is shortened without cutting. On the other hand, by pulling the upper rail left/eight extension 11/12 against upper rail central frame 10, and pulling the lower rail left/eight extension 41/42 against lower rail central frame 40, the length of upper/lower rail 1/4 will increase, thus pulling slat 3 to extend to the same length, so that the width of horizontal blind 1000's width is increased.

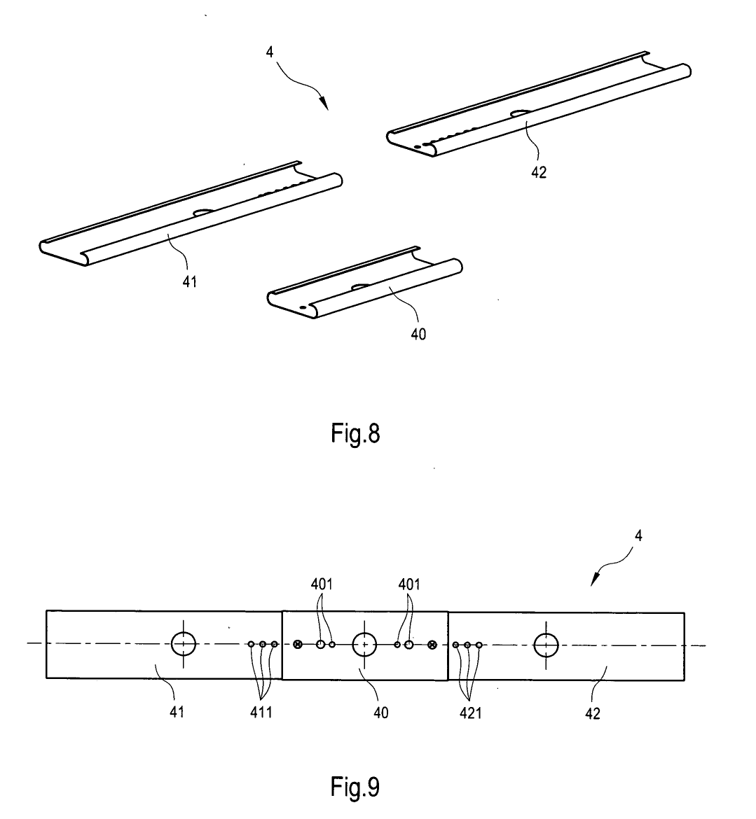

Finally, please refer to FIG. 6 to FIG. 9 showing the three dimensional views of different components of upper rail 1 and lower rail 4, as well as the rear view and bottom view for upper rail 1 and lower rail 4, while adjusting length. Since there are multiple upper rail central frame screw hole 101 on the upper rail central frame, multiple upper rail left/right extension screw hole 112/122 on the right end of upper rail left extension 11 and left end of upper rail right extension 12, after adjusting the length of upper rail 1, the users can use a screw to pass through the overlapped screw holes to fix the length. Similarly, since there are multiple lower rail central frame screw hole 401 on the lower rail central frame, multiple lower rail left/right extension screw hole 412/422 on the right end of lower rail left extension 41 and left end of lower rail right extension 42, after adjusting the length of lower rail 4, the users can use a screw to pass through the overlapped screw holes to fix the length.

Based on the above-stated structure we can see that, by utilizing simple structure and the coordination of different components, horizontal blind 1000 both maintains the full functionality of regular blinds, and can be applied to different sizes of windows without cutting. Thus it gives the user more convenience, and allows manufacturers to mass produce to lower the cost.

What is claimed:

1. A cut-free width-adjustable horizontal blind comprising;
An upper rail is on top of the horizontal blind, the upper rail divided into three sections, an upper rail central frame having ends of its front edge and back edge curve inward to form an upper rail extension holder, an upper rail left extension and an upper rail right extension that extend out to both left and right side from the central frame, and
a set of mechanical components is placed into the upper rail mechanical combination box including several pulling wheel bases, several pulling wheels that are mounted on the bases, a slat flipping box, an axis that passes through these components, a pulling rope stopper, a flipping axis that is beneath the slat flipping box, several pulling ropes that go between the pulling rope stopper, and ladder ropes that are connected to the pulling wheels together with the pulling wheel base to hold the slats, and
several slats between the upper rail and the lower rail, the slats having two sections, a left section and aright section and overlapping in the middle, wherein the right side of the left section overlaps the left side of the right section, and
a lower rail at the bottom of the horizontal blind, the lower rail having three sections:
a lower rail central frame in the center, a lower rail left extension and a lower rail right extension, wherein the left and right sections extend to the left and right sides, respectively, of the central frame.

2. The horizontal blind of claim 1 wherein the abovementioned upper rail central frame is hollow, and has several screw holes on one side.

3. The horizontal blind of claim 1 wherein the upper rail left and right extensions have structures similar to the upper rail central frame and the upper rail left/right extensions are slightly smaller than the upper rail central frame whereby the upper rail left and right extensions are held by the upper rail central frame to form the upper rail.

4. The horizontal blind of claim 3 wherein there are several screw holes on the right side of the upper rail left extension.

5. The horizontal blind of claim 3 wherein there are several screw holes on the left side of the upper rail right extension.

6. The horizontal blind of claim 1 wherein the upper rail extension slider can glide along the upper rail extension holder, thus adjusting the length of the upper rail, and connecting upper rail central frame, upper rail left extension, and upper rail right extension together.

7. The horizontal blind of claim 1 wherein at the end of one of the upper rail extensions there is a slat flipping box hole and a pulling rope stopper.

8. The horizontal blind of claim 1 wherein the axis passes through the pulling wheel bases and the slat flipping box of the blind mechanical component set, and can glide along them.

9. The horizontal blind of claim 1 wherein the slat left section is a slat with an arc profile, with at least one pulling rope hole in the middle.

10. The horizontal blind of claim 1 wherein the slat right section is the mirror image shape of the slat left section.

11. The horizontal blind of claim 1 wherein at the bottom of the lower rail central frame are several screw holes.

12. The horizontal blind of claim 1 wherein the structure of the lower rail left and right extensions are similar to the lower rail central frame, and the lower rail left and right extensions are slightly smaller than the lower rail central frame and are held by the lower rail central frame to form the lower rail.

13. The horizontal blind of claim 12 wherein there are several screw holes on the right side of the lower rail left extension.

14. The horizontal blind of claim 12 wherein there are several screw holes on the left side of the upper rail right extension.

15. The horizontal blind of claim 1 wherein the lower rail extension slider can glide along the lower rail extension holder, thus adjusting the length of the lower rail, and connecting lower rail central frame, lower rail left extension, and lower rail right extension together.
